(19) United States
(12) Patent Application Publication
(10) Pub. No.: US 2020/0091569 A1
(43) Pub. Date: Mar. 19, 2020

(54) METHOD FOR DETERMINING A PRESSURE INSIDE A HOUSING OF A BATTERY CELL, AND BATTERY CELL

(71) Applicant: Robert Bosch GmbH, Stuttgart (DE)

(72) Inventors: Daniel Sauerteig, Bamberg (DE); Holger Reinshagen, Bamberg (DE); Silvan Poller, Neisseaue Ot Kaltwasser (DE)

(21) Appl. No.: 15/750,913

(22) PCT Filed: Aug. 3, 2016
(86) PCT No.: PCT/EP2016/068498

§ 371 Date: Feb. 7, 2018

(30) Foreign Application Priority Data
Aug. 7, 2015 (DE) 10 2015 215 091.7

(51) Int. Cl. H01M 10/48

(52) U.S. Cl. CPC H01M 10/484; H01M 2220/20; H01M 10/486

(57) ABSTRACT

The invention relates to a method for determining a pressure inside a housing (3) of a battery cell (2), comprising a measuring electrode (70) arranged inside the housing (3) and an electrode unit (10) arranged inside the housing (3), having a cathode, an anode (21) and a separator (18) impregnated with an electrolyte, wherein the housing (3) is at least partially electrically conductive. In addition, an electrical impedance between the measuring electrode (70) and the housing (3) is measured, and the pressure inside the housing (3) is determined from the electrical impedance. The invention also relates to a battery cell (2) comprising a housing (3) that is at least partially electrically conductive, a measuring electrode (70) arranged inside the housing (3), and an electrode unit (10) arranged inside the housing (3) and having a cathode, an anode (21) and a separator (18) impregnated with an electrolyte. In addition, the separator (18) is arranged between the housing (3) and the measuring electrode (70) in such a way that an electrical impedance between the measuring electrode (70) and the housing (3) can be measured, or an insulation layer (50) is provided in contact with the housing (3), which is arranged between the housing (3) and the measuring electrode (70) in such a way that an electrical impedance between the measuring electrode (70) and the housing (3) can be measured.

### BACKGROUND OF THE INVENTION

The invention relates to a method for determining a pressure inside a housing of a battery cell, which comprises a measurement electrode arranged inside the housing and an electrode unit arranged inside the housing, and the housing of which battery cell is at least partly electrically conductive. The invention also relates to a battery cell, which comprises a housing, which is at least partly electrically conductive, a measurement electrode arranged inside the housing and an electrode unit arranged inside the housing.

Electrical energy can be stored by means of batteries. Batteries convert chemical reaction energy to electrical energy. Here is where primary batteries and secondary batteries differ. Primary batteries are functional only once, whereas secondary batteries, which are also referred to as rechargeable batteries, can be recharged. In this case, a battery comprises one or more battery cells.

So-called lithium-ion battery cells, in particular, are used in a rechargeable battery. Said lithium-ion battery cells are distinguished, inter alia, by high energy densities, thermal stability and extremely low self-discharge. Lithium-ion battery cells are used, inter alia, in motor vehicles, in particular in electric vehicles (EV), hybrid vehicles (HEV), and plug-in hybrid vehicles (PHEV).

Lithium-ion battery cells have a positive electrode, which is also referred to as the cathode, and a negative electrode, which is also referred to as the anode. The cathode and the anode each comprise a current collector to which an active material is applied. The active material for the cathode is a metal oxide, for example. The active material for the anode is graphite, for example. However, silicon is also prevalent as the active material for anodes.

Lithium atoms are stored in the active material of the anode. During a discharging process, electrons in an outer circuit flow from the anode to the cathode. Inside the battery cell, during a discharging process, lithium ions migrate from the anode to the cathode. In the process, the lithium ions are removed from the active material of the anode in a reversible manner, which is also referred to as delithiation. In a charging process of the battery cell, the lithium ions migrate from the cathode to the anode. In the process, the lithium ions are stored again in the active material of the anode in a reversible manner, which is also referred to as lithiation.

The electrodes of the battery cell are configured in a foil-like manner and, with the interposition of a separator that separates the anode from the cathode, are wound to form an electrode winding. An electrode winding of this kind is also referred to as a jelly roll. The electrodes can also be layered above one another to form an electrode stack or form an electrode unit in another way. A battery cell generally comprises one or more electrode units.

The two electrodes of the electrode unit are electrically connected to poles of the battery cell, which are also referred to as terminals, by means of collectors. The electrodes and the separator are surrounded by a generally liquid electrolyte. The electrolyte is conductive to the lithium ions and enables the lithium ions to be transported between the two electrodes. In particular, the separator is impregnated with the liquid electrolyte.

The battery cell further has a cell housing, which is produced, for example, from aluminum. The cell housing is generally of prismatic, in particular cuboidal, configuration and is of pressure-resistant design. However, other housing shapes, for example circular-cylindrical, or else flexible pouch cells, are also known.

For safe operation of a battery cell, it is necessary to monitor up-to-date parameters of the battery cell. Said parameters include, inter alia, a voltage applied to the terminals, a current flowing through the battery, and a temperature outside the housing. To determine further parameters, in particular a pressure inside the housing and a temperature inside the housing, it is known to provide corresponding sensors inside the housing of the battery cell.

US 2002/0155327 A1 discloses a battery cell having a cathode and a plurality of anode regions. An electrolyte is provided here between the cathode and the anode regions. In addition, sensors, for example pressure sensors, are provided.

US 2014/0004389 A1 discloses a battery cell having an electrode unit and a plurality of sensors. The sensors serve, inter alia, to measure a temperature of the battery cell.

US 2013/0004811 A1 discloses a battery cell having a temperature sensor. The temperature sensor can in this case be integrated into an anode, into a cathode or into a separator.

US 2006/0246345 A1 describes a battery module, which monitors mechanical pressures by piezo sensors between individual battery cells.

DE 10 2007 063 188 A1 discloses a battery cell having an external pressure sensor, wherein the pressure sensor detects the battery state when the battery cell deforms. The pressure sensor is in this case integrated into the housing of the battery cell from the outside.

DE 10 2012 209 397 A1 discloses a battery cell with a pressure sensor located inside, which is embodied as a foil and is arranged between the electrode winding and the housing. The sensor has resistive, capacitive, piezoresistive and piezoelectric functional elements. An electrode connection can in this case function as a signal line.

### SUMMARY OF THE INVENTION

A method for determining a pressure inside a housing of a battery cell is proposed. In this case, the battery cell comprises a measurement electrode arranged inside the housing and an electrode unit arranged inside the housing, said electrode unit having a cathode, an anode and a separator impregnated with an electrolyte. The housing is embodied to be at least partly electrically conductive. In this case, the housing is free of potential, that is to say is not electrically connected to either the anode or the cathode.

In accordance with the invention, an electrical impedance between the measurement electrode and the housing is measured. In particular, an ohmic resistance and a capacitance between the measurement electrode and the housing is measured. In this case, inductance is of secondary importance. The pressure inside the housing is then determined from the measured electrical impedance, in particular from the measured ohmic resistance and from the measured capacitance. There is a correlation here between the measured electrical impedance, in particular the measured capacitance and the measured resistance, and the pressure inside the housing. This correlation is generally non-linear.

In accordance with one advantageous configuration of the invention, the electrical impedance, that is to say the ohmic resistance and the capacitance, of the separator of the electrode unit of the battery cell, said separator being impregnated with the electrolyte, is measured. The electrolyte has an ionic conductivity. Furthermore, the electrolyte acts as a dielectric and has a relative permittivity. In the event of pressure loading on the separator, pores of the separator in which the electrolyte is contained are deformed. As a result, the ionic conductivity of the separator impregnated with the electrolyte changes. Furthermore, the relative permittivity of the separator impregnated with the electrolyte changes as a result.

A change in the ionic conductivity of the separator impregnated with the electrolyte can be recognized by a change in the measured ohmic resistance. A change in the relative permittivity of the separator impregnated with the electrolyte can be recognized by a change in the measured capacitance. After the electrical impedance, that is to say the ohmic resistance and the capacitance, of the separator impregnated with the electrolyte has been measured, the pressure inside the housing of the battery cell is then determined between the measurement electrode and the housing based on the known correlation between the measured electrical impedance and the pressure inside the housing.

In accordance with a further advantageous configuration of the invention, the electrical impedance, in particular the capacitance, of an insulation layer of the battery cell, said insulation layer bearing against the housing, is measured. The insulation layer acts as a dielectric and has a relative permittivity. In the event of pressure loading on the insulation layer, the insulation layer is deformed. As a result, the relative permittivity of the insulation layer changes.

A change in the relative permittivity of the insulation layer can be recognized by a change in the measured impedance, in particular the measured capacitance. After the impedance, in particular the capacitance, of the insulation layer between the measurement electrode and the housing has been measured, the pressure inside the housing is then determined based on the known correlation between the measured impedance and the pressure inside the housing.

In accordance with one advantageous development of the invention, the measurement electrode is the anode or the cathode of the electrode unit of the battery cell. In this case, an outer layer of the anode or of the cathode, in particular, serves as the measurement electrode. In this case, an additional electrode is not required inside the housing and, as a result, an additional housing bushing is not required.

In accordance with another advantageous development of the invention, the measurement electrode is an additional counterelectrode. In this case, the position and the size of the measurement electrode can be precisely determined.

An alternating voltage is preferably applied between the measurement electrode and the housing in order to measure the electrical impedance, in particular the ohmic resistance and the capacitance. The alternating voltage can be, for example, a square-wave voltage, a triangular voltage or a harmonic AC voltage. When a DC voltage is applied over a relatively long period, the electrolyte could become polarized, as a result of which it would not be possible to measure the ohmic resistance in an error-free manner.

A temperature inside the housing is advantageously additionally determined from the electrical impedance, in particular from the ohmic resistance and from the capacitance. There is also a correlation between the measured electrical impedance, in particular the measured capacitance and the measured resistance, and the temperature inside the housing. This correlation is also generally non-linear.

The correlation between the measured electrical impedance, in particular the measured capacitance and the measured resistance, and the pressure inside the housing is dependent on the frequency of the applied voltage. The correlation between the measured electrical impedance, in particular the measured capacitance and the measured resistance, and the temperature inside the housing is also dependent on the frequency of the applied voltage. However, said correlations are different.

The electrical impedances, in particular the ohmic resistances and the capacitances, between the measurement electrode and the housing are therefore advantageously measured at a plurality of frequencies. The pressure and the temperature inside the housing are then determined from the measured electrical impedances. In particular, an impedance locus curve can be plotted from the measured electrical impedances and the pressure and the temperature inside the housing can then be determined from the plotted impedance locus curve.

A battery cell, which comprises a housing, which is at least partly electrically conductive, a measurement electrode arranged inside the housing and an electrode unit arranged inside the housing, said electrode unit having a cathode, an anode and a separator impregnated with an electrolyte, is also proposed. In this case, the housing is free of potential, that is to say is not electrically connected to either the anode or the cathode.

In the battery cell according to the invention, the separator is arranged between the housing and the measurement electrode in such a way that an electrical impedance, in particular an ohmic resistance and a capacitance, between the measurement electrode and the housing can be measured.

An insulation layer bearing against the housing is advantageously provided, said insulation layer having at least one cutout, wherein the separator bears against the insulation layer and bears against the housing in the region of the cutout.

A battery cell is also proposed, in which an insulation layer bearing against the housing is provided in accordance with the invention, wherein the insulation layer is arranged between the housing and the measurement electrode in such a way that an electrical impedance, in particular a capacitance, between the measurement electrode and the housing can be measured.

In accordance with one advantageous configuration of the invention, the measurement electrode is the anode or the cathode of the battery cell.

In accordance with one advantageous configuration of the invention, the measurement electrode is an additional counterelectrode.

In accordance with one advantageous development of the invention, the counterelectrode has a plurality of measurement areas insulated from one another. A counterelectrode configured in this way permits spatially resolved measurement of the impedance. The pressure and the temperature can therefore be determined at different locations inside the housing.

A method according to the invention and a battery cell according to the invention are advantageously used in an electric vehicle (EV), in a hybrid vehicle (HEV), in a plug-in hybrid vehicle (PHEV), or in a consumer electronics product. Consumer electronics products are understood to be, in particular, cell phones, tablet PCs or notebooks.

When applying the method according to the invention, additional sensor elements, in particular pressure sensors and temperature sensors, are not required. The method according to the invention can be applied to battery cells having a prismatic housing, to battery cells having a circular-cylindrical housing and to pouch cells.

Furthermore, when using the anode or the cathode as the measurement electrode, a separate housing bushing for the measurement electrode is not required. When using a counterelectrode, which has a plurality of measurement areas insulated from one another, a spatially resolved measurement of the impedance is possible. The pressure and the temperature can therefore be determined at different locations inside the housing. This makes it possible, in particular, to detect defects at an early stage, such as short circuits, for example, which lead to localized heating.

### BRIEF DESCRIPTION OF THE DRAWINGS

Embodiments of the invention are explained in more detail with reference to the drawings and the following description.

In the drawings:

FIG. 1 shows a schematic illustration of a battery cell in accordance with a first embodiment,

FIG. 2 shows a schematic illustration of a battery cell in accordance with a second embodiment,

FIG. 3 shows a schematic illustration of a battery cell in accordance with a third embodiment and

FIG. 4 shows a schematic illustration of a counterelectrode.

### DETAILED DESCRIPTION

In the following description of the embodiments of the invention, identical or similar elements are denoted by identical reference signs, wherein a repeated description of these elements will be dispensed with in individual cases. The figures depict the subject matter of the invention only schematically.

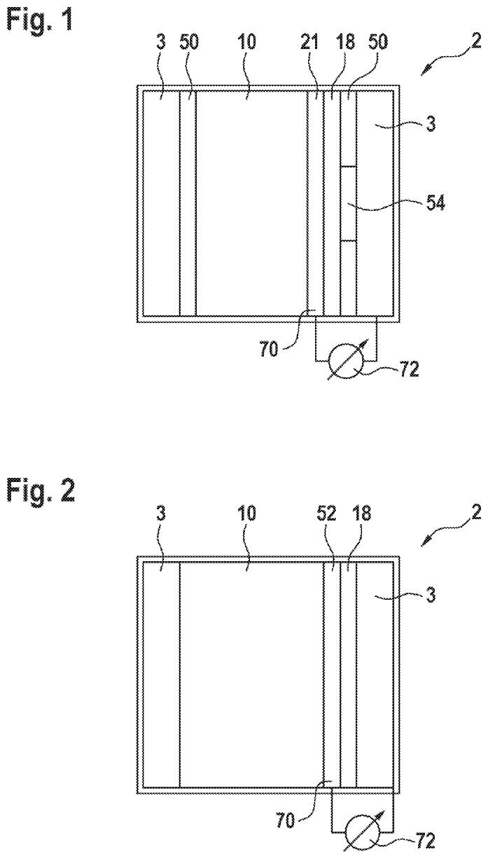

FIG. 1 shows a schematic illustration of a battery cell 2 in accordance with a first embodiment. The battery cell 2 comprises a housing 3, which is of prismatic, in the present case cuboidal, design. The housing 3 is embodied in the present case as electrically conductive and is produced from aluminum, for example.

The battery cell 2 comprises a negative terminal and a positive terminal 12. A voltage provided by the battery cell 2 can be tapped off via the terminals. Further, the battery cell 2 can also be charged via the terminals.

An electrode unit 10 is arranged inside the housing 3 of the battery cell 2, said electrode unit being embodied in the present case as an electrode winding. The electrode unit 10 has two electrodes, namely an anode 21 and a cathode (not visible here). The anode 21 and the cathode are each embodied in a foil-like manner and, with the interposition of a separator 18, are wound to form the electrode winding. Instead of an electrode winding, the electrode unit 10 can also be embodied as an electrode stack, for example.

The anode 21 comprises an anodic active material, which is embodied in a film-like manner. The anode 21 further comprises an anodic current collector, which is likewise of film-like design. The anodic active material and the anodic current collector are placed against one another in a two-dimensional manner and are connected to one another. The anodic current collector is embodied as electrically conductive and is produced from a metal, for example from copper. The anodic current collector is electrically connected to the negative terminal of the battery cell 2 by means of a collector.

The cathode comprises a cathodic active material, which is embodied in a film-like manner. The cathode further comprises a cathodic current collector, which is likewise of film-like design. The cathodic active material and the cathodic current collector are placed against one another in a two-dimensional manner and are connected to one another. The cathodic current collector is embodied as electrically conductive and is produced from a metal, for example from aluminum. The cathodic current collector is electrically connected to the positive terminal of the battery cell 2 by means of a collector.

The anode 21 and the cathode are isolated from one another by the separator 18. The separator 18 is likewise of film-like design. The separator 18 is ionically conductive, that is to say is permeable to lithium ions. The housing 3 of the battery cell 2 is filled with a liquid electrolyte, which is of ionically conductive design. In particular, the separator 18 is impregnated with the liquid electrolyte.

In the illustration shown, the outer layer of the anode 21 and the outer layer of the separator 18 are illustrated. An insulation layer 50 is arranged on the inner side of the housing 3. The separator 18 in this case bears against the insulation layer 50.

The insulation layer 50 comprises one or more cutouts 54. One of the cutouts 54 is illustrated in the present case. When the pressure increases inside the electrode unit 10, the separator 18 is pressed into the cutout 54 and in the process makes contact with the housing 3.

The anode 21 acts in the present case as the measurement electrode 70. Alternatively, the cathode can also act as the measurement electrode. A measurement device 72 is electrically connected between the measurement electrode 70 and the housing 3. An impedance between the measurement electrode 70, that is to say the anode 21, and the housing 3 can be measured by means of the measurement device 72. In the present case, the impedance of the separator 18 is measured using the measurement device 72.

After the electrical impedance, that is to say the ohmic resistance and the capacitance, of the separator 18 impregnated with the electrolyte has been measured, the pressure inside the housing 3 is then determined based on a known correlation between the measured electrical impedance and the pressure inside the housing 3.

FIG. 2 shows a schematic illustration of a battery cell 2 in accordance with a second embodiment. The battery cell 2 in accordance with the second embodiment is similar to the battery cell 2 in accordance with the first embodiment shown in FIG. 1. The following text therefore deals primarily with the differences.

In the illustration shown here, the anode 21 is not visible. The battery cell 2 in accordance with the second embodiment comprises a counterelectrode 52, which is arranged in the electrode unit 10. The counterelectrode 52 is in this case covered by the outer layer of the separator 18.

The separator 18 bears against the inner surface of the housing 3. The counterelectrode 52 acts as the measurement electrode 70. In the present case, the measurement device 72 is electrically connected between the measurement electrode 70, that is to say the counterelectrode 52, and the housing 3. The impedance of the separator 18 is measured by means of the measurement device 72.

After the electrical impedance, that is to say the ohmic resistance and the capacitance, of the separator 18 impregnated with the electrolyte has been measured, the pressure inside the housing 3 is then determined based on a known correlation between the measured electrical impedance and the pressure inside the housing 3.

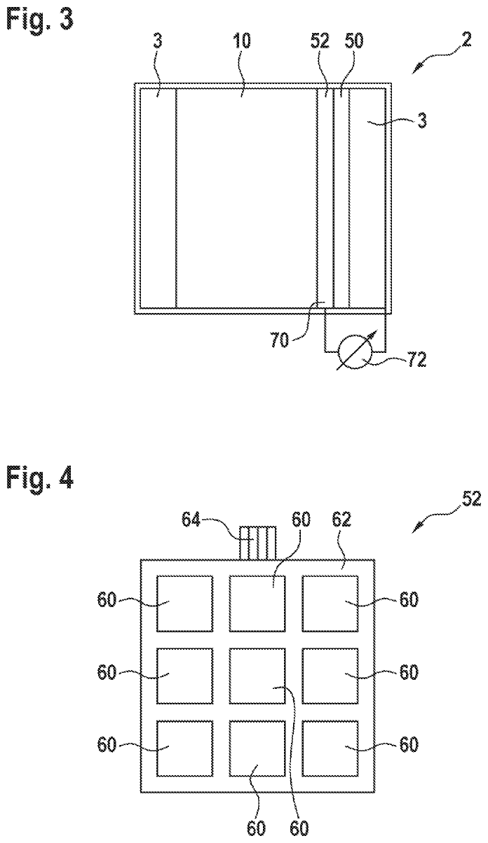

FIG. 3 shows a schematic illustration of a battery cell 2 in accordance with a third embodiment. The battery cell 2 in accordance with the third embodiment is similar to the battery cell 2 in accordance with the first embodiment, which is illustrated in FIG. 1. The following text therefore deals in particular with the differences.

The battery cell 2 in accordance with the third embodiment comprises a counterelectrode 52. In this case, the counterelectrode 52 is outside of the electrode unit 10. The anode 21 and the separator 18 are not visible in the illustration shown here. An insulation layer 50 is provided between the counterelectrode 52 and the housing 3.

The counterelectrode 52 can also be coated with the insulation layer 50. The counterelectrode 52 acts as the measurement electrode 70. Alternatively, the anode 21 or the cathode can also act as the measurement electrode 70. A measurement device 72 is electrically connected between the measurement electrode 70, that is to say the counterelectrode 52, and the housing 3. An impedance of the insulation layer 50 can be measured by means of the measurement device 72.

Said insulation layer 50 is of electrically insulated design, that is to say is not electrically conductive. The measured impedance of the insulation layer 50 therefore approximately corresponds to the capacitance, which is formed by the insulation layer 50 between the housing 3 and the measurement electrode 70. An electrical resistance cannot be measured.

After the electrical impedance, that is to say the capacitance, of the insulation layer 50 has been measured, the pressure inside the housing 3 is then determined based on a known correlation between the measured electrical impedance and the pressure inside the housing 3.

FIG. 4 shows a schematic illustration of a counterelectrode 52. The counterelectrode 52 comprises a plastic film 62 to which a plurality of measurement areas 60 are applied. In the present case, the measurement areas 60 are metal layers, which are vapor-deposited on the plastic film 62, for example.

The measurement areas 60 are regularly arranged in the form of a matrix. The individual measurement areas 60 of the counterelectrode 52 are thus located in a plurality of rows and a plurality of columns next to one another on the plastic film 62. However, other arrangements of the measurement areas 60 on the plastic film 62 are also conceivable.

Each of the measurement areas 60 of the counterelectrode 52 is connected to a contact element 64 by means of a conductor (not shown). The contact element 64 comprises a plurality of metallic strands to which the individual measurement areas 60 are contact-connected.

A plurality of conductors (not shown here) extend from the contact element 64 through a corresponding bushing in the housing 3 of the battery cell 2 out of the housing 3. It is possible to measure a respective impedance at a plurality of different locations close to one another inside the housing 3 of the battery cell 2 by means of the counterelectrode 52 shown here.

The invention is not restricted to the exemplary embodiments described here and the aspects highlighted therein. Rather, within the scope of the claims, numerous modifications within the capabilities of those skilled in the art are possible.

1. A method for determining a pressure inside a housing (3) of a battery cell (2) having a measurement electrode (70) arranged inside the housing (3) and an electrode unit (10) arranged inside the housing (3), said electrode unit having a cathode, an anode (21) and a separator (18) impregnated with an electrolyte, wherein the housing (3) is at least partly electrically conductive, the method comprising
measuring an electrical impedance between the measurement electrode (70) and the housing (3) is measured, and in that
determining the pressure inside the housing (3), wherein the pressure is determined from the electrical impedance.

2. The method as claimed in claim 1, further comprising measuring an electrical impedance of the separator (18) of the electrode unit (10).

3. The method as claimed in claim 1, further comprising measuring an impedance of an insulation layer (50) bearing against the housing (3).

4. The method as claimed in claim 1, characterized in that the measurement electrode (70) is the anode (21) or the cathode of the electrode unit (10).

5. The method as claimed in claim 1, characterized in that the measurement electrode (70) is an additional counterelectrode (52).

6. The method as claimed in claim 1, characterized in that an alternating voltage is applied between the measurement electrode (70) and the housing (3) in order to measure the electrical impedance.

7. The method as claimed in claim 1, further comprising determining a temperature inside the housing (3) from the electrical impedance.

8. A battery cell (2), comprising
a housing (3), which is at least partly electrically conductive,
a measurement electrode (70) arranged inside the housing (3), and
an electrode unit (10) arranged inside the housing (3), said electrode unit having a cathode, an anode (21) and a separator (18) impregnated with an electrolyte,
wherein the separator (18) is arranged between the housing (3) and the measurement electrode (70) in such a way that an electrical impedance between the measurement electrode (70) and the housing (3) can be measured.

9. The battery cell (2) as claimed in claim 8, further comprising an insulation layer (50) bearing against the housing (3), said insulation layer having at least one cutout (54), wherein the separator (18) bears against the insulation layer (50) and bears against the housing (3) in a region of the cutout (54).

10. A battery cell (2) comprising
a housing (3), which is at least partly electrically conductive,
a measurement electrode (70) arranged inside the housing (3),
an electrode unit (10) arranged inside the housing (3), said electrode unit having a cathode, an anode (21) and a separator (18) impregnated with an electrolyte, and
an insulation layer (50) bearing against the housing (3), wherein the insulation layer (50) is arranged between the housing (3) and the measurement electrode (70) in such a way that an electrical impedance between the measurement electrode (70) and the housing (3) can be measured.

11. The battery cell (2) as claimed in claim 8, characterized in that the measurement electrode (70) is the anode (21) or the cathode of the battery cell (2).

12. The battery cell (2) as claimed in claim 8, characterized in that the measurement electrode (70) is an additional counterelectrode (52).

13. The battery cell (2) as claimed in claim 12, characterized in that the counterelectrode (52) has a plurality of measurement areas (60) insulated from one another.

14. (canceled)

15. The battery cell (2) as claimed in claim 10, characterized in that the measurement electrode (70) is the anode (21) or the cathode of the battery cell (2).

16. The battery cell (2) as claimed in claim 10, characterized in that the measurement electrode (70) is an additional counterelectrode (52).

17. The battery cell (2) as claimed in claim 16, characterized in that the counterelectrode (52) has a plurality of measurement areas (60) insulated from one another.
